(19) United States
(12) Patent Application Publication
(10) Pub. No.: US 2011/0308223 A1
(43) Pub. Date: Dec. 22, 2011

(54) METHOD FOR MECHANICALLY PROCESSING OR STRAIGHTENING AN EDGE

(75) Inventor: Ueli BALDINGER, Lengnau (CH)

(73) Assignee: UELI BALDINGER GMBH, Lengnau (CH)

(21) Appl. No.: 13/160,079

(22) Filed: Jun. 14, 2011

(30) Foreign Application Priority Data
Jun. 20, 2010 (EP) 10 405 118.0

(51) Int. Cl. A01D 34/73

(52) U.S. Cl. 56/256

(57) ABSTRACT

A method for mechanically processing or straightening a boundary line of a groundcover of grass, turf, garden plantings, forest, or the like adjacent to a utility area, including executing a cutting movement along the edge area of the groundcover to separate the groundcover from the utility area along the boundary line. For this purpose, a rotating, motor-driven, more-or-less circular separating disk, which penetrates into the edge area of the groundcover of grass, etc. along a certain boundary line, and which is set at an acute angle to the forward travel direction, is mounted on a support frame of a self-propelled work machine.

### CROSS-REFERENCE TO RELATED APPLICATIONS

The present application claims priority of EP 10 405 118.0, filed Jun. 20, 2010, the priority of this application is hereby claimed and this application is incorporated herein by reference.

### BACKGROUND OF THE INVENTION

The invention pertains to a method for mechanically processing or straightening an edge of an area with a groundcover of grass, turf, garden plantings, forest, etc.

Groundcovers or topsoil layers of the type indicated above must be set off or set back occasionally or periodically from utility areas such as driveways, paths, racetracks, playing fields, and features in golf courses and parks. This is normally done by experienced personnel using mattocks, spades, shovels, or similar tools, whether this be for bunkers (sand traps) in golf courses, the outer boundaries of which must be laboriously recut several times during the course of the season, or for the edges of driveways and paths, in brief, wherever the adjacent layer of topsoil spreads out onto a utility area.

The separated sod, which has come loose to some extent, must be picked up and carted away. “Sod” is the term used for the overgrowth of grass and/or weeds on the ground, topsoil, or groundcover, i.e., growth which acquires cohesion through the presence of the plant material and roots. Terms related to sod include grass cover, lawn, heath, etc.

The side edges of driveways and paths must also be freed of overgrowth by laborious manual use of shovels, spades, picks, mattocks, etc. Flowerbeds in parks are also affected by this natural event. The same problem obviously also occurs in the case of transplanted sod used, for example, for grass playing fields.

### SUMMARY OF THE INVENTION

The goal of the present invention is to create a method of the type described above by means of which, in a less strenuous manner, within a shorter time, and with less manual effort, the boundary line at the edge of a layer of topsoil or of a groundcover which has spread over a utility area can be mechanically produced, straightened, or set back.

According to the invention, this goal is achieved by a cutting movement, which is guided along the boundary line of the groundcover to separate the groundcover from the utility area along the boundary line. In this way, a cleanly drawn boundary line can be produced.

This process can be carried out by means of a device or a corresponding mechanism which performs a cutting movement and is mounted on a self-propelled work machine.

The cutting movement advantageously exerts a lateral conveying movement on the edge material of the groundcover which has been separated from the groundcover.

The cutting movement is preferably exerted by a force acting on the groundcover such as a force resulting from gravity.

The cutting movement acting on the groundcover is advantageously performed by a rotating, preferably uninterrupted cutting edge.

In the area where the cutting occurs, the cutting movement can proceed in the direction opposite the forward travel direction, so that the cut-away groundcover material can be conveyed.

In the area where the cutting occurs, the cutting edge for this purpose can be oriented at an acute angle to the desired boundary line, wherein this angle is preferably settable and adjustable.

The speed of the cutting edge can be greater than the forward-travel speed, so that the reactive forces acting on the cutting edge are reduced.

Another goal of the invention is to create a device by means of which, in a simple manner and in less time than it would take if the work were done manually, a uniform boundary line can be produced between a utility area and an area covered by grass, turf, or similar material by mechanically straightening the edge area.

According to the invention, the goal is achieved in that, on a support frame of a self-propelled work machine, a more-or-less circular, rotating, motor-driven separating disk is mounted, which penetrates into the edge of the groundcover of grass, etc., along a certain boundary line, the disk being positioned at an acute angle to the forward travel direction. Of course, the device could also comprise a second separating disk mounted at an angle to the first separating disk, so that a wider edge can be cut off from the groundcover in a single pass.

The edge area extending around the circumference of the separating disk advantageously curves away from the boundary line; this edge area exerts a slight conveying action on the cut-off groundcover material.

The separating disk is preferably designed with a convex surface facing the boundary line; this surface further supports the cutting or peeling-away action and the separation of the groundcover material to be carried away from the remaining groundcover, and it also increases the stability and stiffness of the separating disk.

These advantageous properties are not changed by providing the separating disk with a concave shape on the side facing away from the boundary line of the groundcover, but it does make it possible to produce or form the disk out of a piece of sheet steel or the like, for example. The curved shape of the separating disk has the effect of exerting a conveying action, directed laterally and to the rear, on the topsoil material separated from the remaining groundcover.

The separating action can be improved by providing a cutting edge around the circumference, which reduces the amount of cutting force required.

So that the separating disk can be adapted to the height of the boundary line or adjusted to match the height of the boundary line and its orientation, the disk is mounted on the work machine in such a way that that its height and lateral position can be adjusted.

The acute angle which the separating disk forms to the forward travel direction or to the boundary line of the groundcover can also be set and adjusted. This possibility allows the device to be adapted to the conditions of the topsoil to be processed.

It is advantageous for the separating disk to be followed by a lifting-type conveying mechanism, which extends in the direction opposite the forward travel direction of the device. This conveying mechanism carries away the topsoil material which is present on the utility area and which has been separated by the separating disk from the edge of the groundcover and advisably conveys it to an easy-to-empty collection bin, which is mounted on the rear of the device.

The separating disk and the conveying mechanism preferably form a unit and are arranged height-adjustably on a mounting block. The unit can be detached from the work machine.

Because the width and thickness of the edges of groundcovers are different and can also change from place to place, it is advisable to have the ability to operate the separating disk at a cutting or peripheral speed which is different, that is, faster or slower, from the conveying speed of the conveying device. For this purpose, the drive of the separating disk and the drive of the conveying mechanism or conveying mechanism can be provided with independently controlled motors.

The conveying mechanism advantageously comprises, at the upstream end, a guide element, which extends more-or-less all the way to the surface of the utility area and guides the groundcover material being supplied by the separating disk, wherein the guide element is in working connection with a following endless transport element, which consists of transport bars oriented transversely to the conveying direction of the groundcover material and traveling around axles spaced a certain distance apart.

It is advantageous to arrange the separating disk to one side of a steerable axle or the front axle of the work machine, so that the steering or guiding action can have an effect on the device.

The various features of novelty which characterize the invention are pointed out with particularity in the claims annexed to and forming a part of the disclosure. For a better understanding of the invention, its operating advantages, specific objects attained by its use, reference should be had to descriptive matter in which there are described preferred embodiments of the invention.

### BRIEF DESCRIPTION OF THE DRAWING

In the drawing:

FIG. 1 shows a perspective view of one embodiment of the inventive device;

FIG. 2 shows a partial top view of the embodiment of the device according to FIG. 1.

FIG. 3 shows a view of the device shown partially in FIG. 2, i.e., the device according to the embodiment shown in FIG. 1;

FIG. 4 shows a schematic diagram of an embodiment of the device mounted on a self-propelled work machine;

FIG. 5 shows a view of an alternative embodiment of the device looking in the direction opposite the forward travel direction; and

FIG. 6 shows a top view of the embodiment shown in FIG. 5.

### DETAILED DESCRIPTION OF THE INVENTION

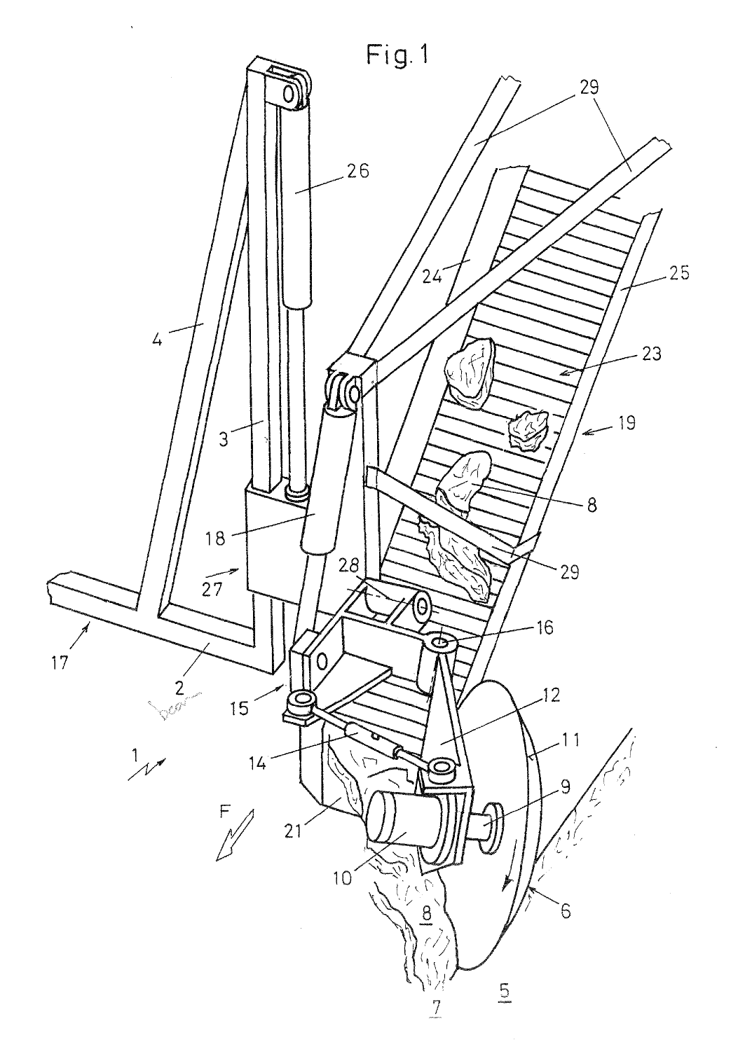

FIG. 1 shows an embodiment of the inventive device 1, which preferably can be attached to and removed from the side of a two-axle work machine (not shown in FIG. 1). For this purpose, a beam 2 is connected to the chassis on the underside of the work machine or tractor; the device 1 is supported on this beam by way of a vertical guide element 3. A lateral strut 4 connects the beam 3 to the upper end, so that a mounting frame 17 is formed. The processing or straightening of the boundary line of an edge area of a groundcover of grass, turf, garden plantings, or forest adjacent to or abutting a utility area such as a bunker of a golf course, a driveway, a path, a playing field, or the like, is accomplished by a cutting movement performed along the edge area of the groundcover. The cutting movement penetrates into the groundcover in guided fashion to remove the overgrown groundcover material from the utility area and thus to form the boundary line. That is, the utility area is freed of a portion of the edge area of the groundcover 5 which has grown over onto the utility area.

The cutting movement is achieved by a force acting on the groundcover, preferably by the force of gravity acting through the work machine and the device 1.

The cutting movement through the groundcover is exerted by the rotating, preferably uninterrupted cutting edge of a cutting tool.

In the area where the cutting actually takes place, the continuous cutting movement proceeds in the direction opposite the forward travel direction of the cutting operation and thus exerts a peeling-off effect on the groundcover material extending onto the utility area.

The cutting movement of the cutting edge can comprise a speed greater than that at which the device provided travels forward.

The cutting edge of the cutting tool is positioned at an acute angle to the course of the boundary line extending along the edge area of the groundcover to be edged.

The device 1 comprises a preferably circular separating disk 6, which, when processing an edge area 7, penetrates far enough to separate at least the groundcover material 8 present on the utility area from the groundcover 5 and pushes this separated material aside.

For this purpose, the separating disk 6, preferably made of steel, is mounted on a drive shaft 9, which is driven by a motor, preferably a hydraulic motor 10.

To improve the cutting and conveying action of the separating disk 6, the circumferential area 11 of the disk curves or bends away from the boundary line and belongs, for example, to the raised surface of the separating disk 6, which preferably comprises a convex shape on the side facing the boundary line.

The hydraulic motor 10 driving the separating disk 6 is connected to hydraulic hoses (not shown) of a hydrostatic drive system, which is well known in itself and therefore is not described or illustrated here. The motor 10 is attached to the free end of a support 12, which is designed as a swing arm, so that the distance between the separating disk 6 and the work machine or the boundary line of the groundcover 5 or a conveying mechanism 19, to be described further below, can be adjusted, for which purpose a length-adjustable connecting rod 14 with left-hand and right-hand threads is provided. The swing arm 12 is mounted on a pivot block 15, which is connected pivotably to the mounting frame 17; the swing arm can thus swing around a slanted axis 16, so that the separating disk 6 can be brought into the proper operation position, especially for the processing or straightening of the overgrown groundcover 5. Instead of the adjustable connecting rod 14, by means of which the position of the separating disk 6 can be corrected, it would also be possible to use a hydraulic piston-cylinder unit, which can be actuated by means of valves from the work machine by the operator of the device 1.

The pivot block 15 is hinged to the mounting block 27 so that it, together with the separating disk 6, can swing around a more-or-less horizontal pivot axis 28. The separating disk can thus be moved into a suitable operating position, from which it can also be retracted or raised into a nonoperating position by a piston-cylinder unit 18 attached to the mounting block 27. The end of the piston-cylinder unit 18 opposite the attachment end is connected to the pivotable end of the pivot block 15, to which the end of the connecting rod 14 facing away from the motor 10 is hinged.

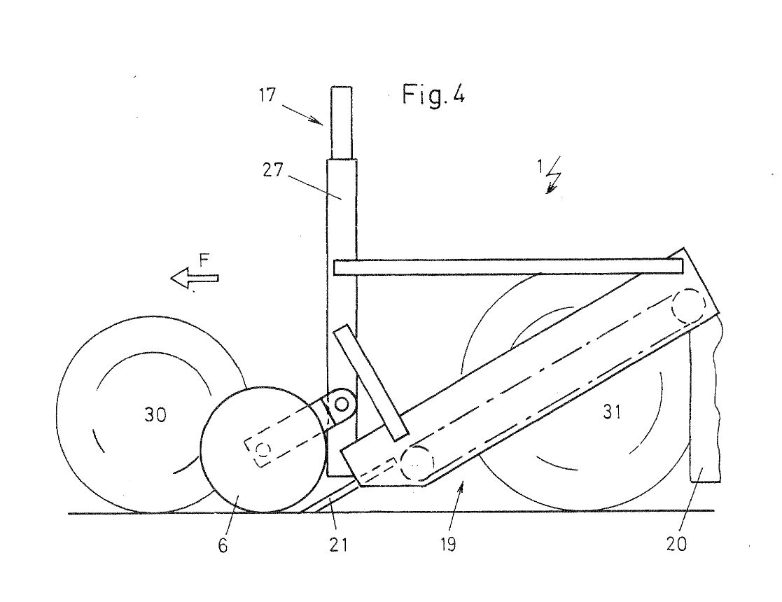

For the groundcover material 8 cut off by the separating disk 6, a conveying mechanism 19 can be provided, which follows after the separating disk and rises toward the rear. The conveying mechanism accepts or takes up the separated groundcover material 8 and, for example, transports it into a collecting bin 20 at the rear of the device 1 (see FIG. 4).

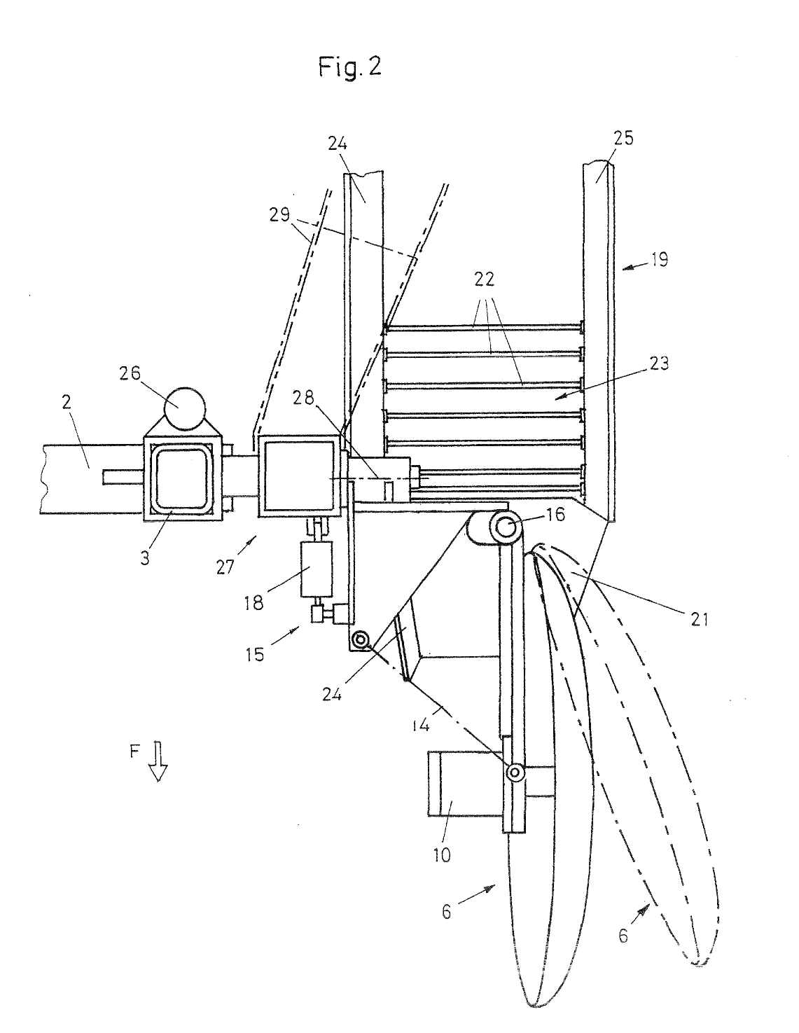

By means of the separating disk 6, which, when in the operating position, is at a slant (at an acute angle to the boundary line), and by means of the device 1, which moves forward along the edge area 7 of the groundcover 5, the peeled-off groundcover material 8 is guided by way of a guide or shovel element 21 onto an endless traveling conveying element 23, which is formed out of conveying bars 22 arranged a certain distance apart. See also FIG. 2, in which the operating position of the separating disk 6 is shown in dash-dot line.

Of course, a conveying mechanism with a conveyor belt could also be used in the conveying mechanism 19.

Side walls 24, 25, which form the lateral boundaries of the conveying mechanism 19 and extend up as far as the forward end of the conveying mechanism 19, are arranged on both sides of the conveying element 23. In the exemplary embodiment shown in FIGS. 1-3, the separating disk 6 and the conveying mechanism 19 form a machine or equipment unit, the height of which can be adjusted on the guide element 3 of the mounting frame 17. For this purpose, a lifting block 27, which can be raised and lowered on the guide element 3 by means of a piston-cylinder unit 26, is provided, to which the separating disk 6 is attached by way of the pivot bearing of the pivot axis 28 of the pivot block 15 and by the piston-cylinder unit 18, and to which the conveying mechanism 19 is also attached by the connecting rods 29.

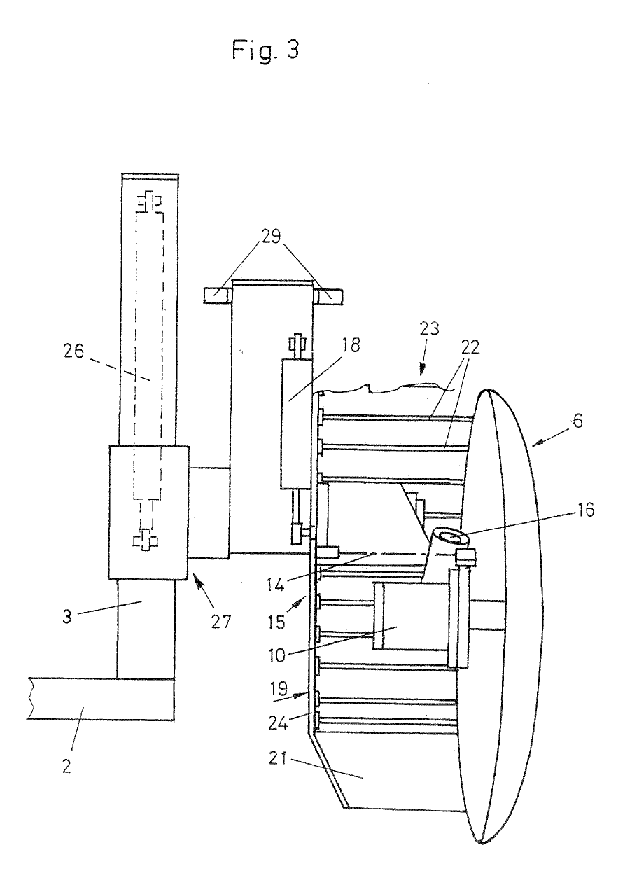

FIGS. 2 and 3 show the bent or curved circumference of the separating disk 6, which comprises a raised surface.

FIG. 4 shows a schematic side view of a front wheel 30 and a rear wheel 31 of a two-axle, self-propelled work machine, to the side of which the device 1 is attached, wherein the arrow F indicates the forward travel direction for the processing of the groundcover 5.

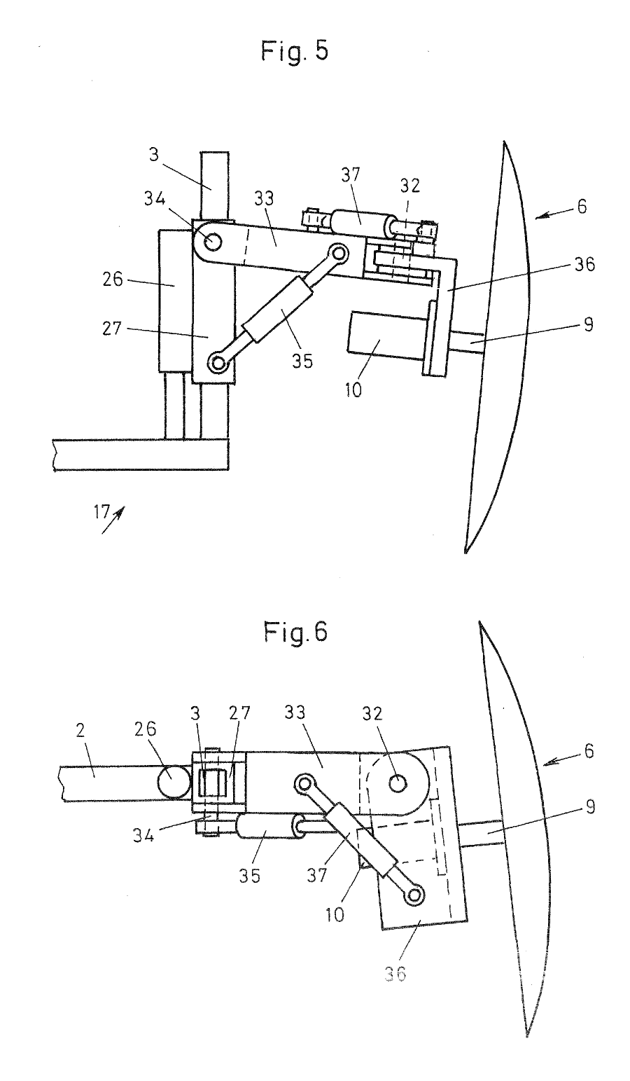

FIGS. 5 and 6 show an alternative embodiment of the device 1, according to which the separating disk 6 can be adjusted with respect to its height on the mounting frame 17 of a work machine, can be tilted into a slanting position, and can be pivoted around an axle 32, the angle of which can be adjusted. For this purpose, a side arm 33 is mounted on the lifting block 27, the height of which on the guide element 3 is adjustable. A lifting cylinder 35 can pivot the side arm around a horizontal axle 34, The side arm carries at its free end a support 36, which holds the separating disk 6 and the motor 10 of the separating disk 6; this support can pivot around the tiltable axle 32, for which purpose a piston-cylinder unit 37 is provided on the side arm 33. The piston-cylinder units 26, 35, 37 are preferably controllable separately, so that the various movements required to adjust the position of the separating disk 6 can be carried out independently of each other.

While specific embodiments of the invention have been shown and described in detail to illustrate the inventive principles, it will be understood that the invention may be embodied otherwise without departing from such principle

We claim:

1. A method for mechanically processing or straightening an edge line of a groundcover of grass, turf, garden plantings, forest, etc., adjacent to a utility area, comprising executing a cutting movement guided along an edge area to separate the groundcover from the utility area along a boundary line.

2. The method according to claim 1, including exerting a lateral conveying movement on the groundcover edge material which has been separated from the groundcover the cutting movement exerting the lateral conveying movement.

3. The method according to claim 1, wherein the cutting movement occurs as a result of an exerted force acting on the groundcover.

4. The method according to claim 1, wherein the cutting movement acting on the groundcover is exerted by a rotating, uninterrupted cutting edge.

5. The method according to claim 4, wherein, in a cutting area, the cutting movement occurs in a direction opposite a forward travel direction.

6. The method according to claim 5, wherein a cutting speed of the cutting edge is greater than a speed of forward travel.

7. The method according to claim 4, including orienting the cutting edge at an acute angle to the boundary line in a cutting area.

8. A device for mechanically processing or straightening a boundary line of a groundcover of grass, turf, garden plantings, forest, or the like, comprising: a rotating, motor-driven, substantially circular separating disk that penetrates into an edge area of the groundcover along the boundary line, the disk being set at an acute angle to a direction of forward travel, and being mountable on a support frame of a self-propelled work machine.

9. The device according to claim 8, wherein the separating disk comprises a circumferential area that bends or curves away from the boundary line of the groundcover.

10. The device according to claim 8, wherein the separating disk comprises a raised surface having a convex side facing the boundary line.

11. The device according to claim 8, wherein the separating disk comprises a concave surface facing away from the boundary line of the groundcover.

12. The device according to claim 8, wherein the separating disk has a circumference formed as a cutting edge.

13. The device according to claim 8, wherein the separating disk is mountable on the work machine so that a height and lateral position of the separating disk is adjustable.

14. The device according to claim 8, wherein the acute angle of the separating disk to the forward travel direction or to the boundary line is settable and adjustable.

15. The device according to claim 8, and further comprising a rising conveying mechanism that follows the separating disk and extends in a direction opposite the forward travel direction.

16. The device according to claim 15, wherein the separating disk and the conveying mechanism are formed as a unit and are mounted height-adjustably on a mounting frame connected to a chassis of the work machine.

17. The device according to claim 15, wherein circumferential speed of the separating disk is settable and adjustable independently of a conveying speed of the conveying mechanism.

18. The device according to claim 15, wherein the conveying mechanism comprises, at the upstream end, a guide element extending to a utility area for receiving the groundcover material supplied by the separating disk, the guide element being followed by an endless conveying element that includes conveying bars, arranged in a row a distance apart transversely to a direction in which the groundcover material is conveyed.

19. The device according to claim 15, wherein the drive of the separating disk and a drive of the conveying mechanism are formed by separate controlled motors.

20. The device according to claim 8, wherein the separating disk is arranged approximately in a lateral working area of a steerable axle of the work machine.
